(19) United States
(12) Patent Application Publication
(10) Pub. No.: US 2017/0220869 A1
(43) Pub. Date: Aug. 3, 2017

(54) AUTOMATIC SUPERCUT CREATION AND ARRANGEMENT

(71) Applicant: Verizon Patent and Licensing Inc., Arlington, VA (US)

(72) Inventors: Devin Blong, Penngrove, CA (US); Gyanesh Pandey, San Jose, CA (US); Tushar Chaudhary, San Francisco, CA (US); Manish Sharma, San Jose, CA (US); Kevin Flores, San Jose, CA (US)

(21) Appl. No.: 15/013,861

(22) Filed: Feb. 2, 2016

(51) Int. Cl. G06K 9/00; G06F 17/30; H04N 21/8549; G11B 27/10; G11B 27/031

(52) U.S. Cl. CPC G06K 9/00751; G11B 27/10; G11B 27/031; H04N 21/8549; G06F 17/3082; G06F 17/30843; G06F 17/3053

(57) ABSTRACT

The creation of a supercut is described using techniques to allow users to efficiently create high quality supercuts. A video clip repository may include a number of video clips. The video clip repository may allow users to browse and view video clips in the repository. A supercut creation tool may operate to identify, based on comparison of search criteria received from a user to the set of tags, video clips, from the set of video clips, that are relevant to the search criteria; determine, based on scores of the video clips, an ordering of the video clips; and generate a supercut of the video clips as a single video corresponding to the video clips and arranged in the determined order.

### BACKGROUND

The term “supercut” refers to a compilation of short video clips that are strung together to create a seamless new work. Typically, the video clips in a supercut are related in some manner, such as being from the same genre, the same television or movie series, including a common actor, etc. A supercut is usually built around a theme, and the goal is to create something that is more than just the sum of its parts. Supercuts are frequently created by “non-professional” content creators, such as by a fan of a particular actor or genre.

Creating a supercut can be a taxing problem as a creator must search through many source videos for relevant content and then clip the desired scenes.

### BRIEF DESCRIPTION OF THE DRAWINGS

FIG. 1 illustrates an example overview of one or more implementations described herein;

FIG. 2 illustrates an example environment in which systems and/or methods described herein may be implemented;

FIG. 3 is a diagram illustrating an example data structure illustrating various types of metadata that may be associated with video clips;

FIG. 4 is a diagram conceptually illustrating functional elements of a supercut creation component;

FIG. 5 illustrates an example process for the creation of supercuts;

FIG. 6 illustrates an example process for automatically determining an ordering of video clips in a supercut;

FIGS. 7A-7E are diagrams illustrating user interfaces relating to an example of a user creating a supercut; and

FIG. 8 is a diagram of example components of a device.

### DETAILED DESCRIPTION OF PREFERRED EMBODIMENTS

The following detailed description refers to the accompanying drawings. The same reference numbers in different drawings may identify the same or similar elements.

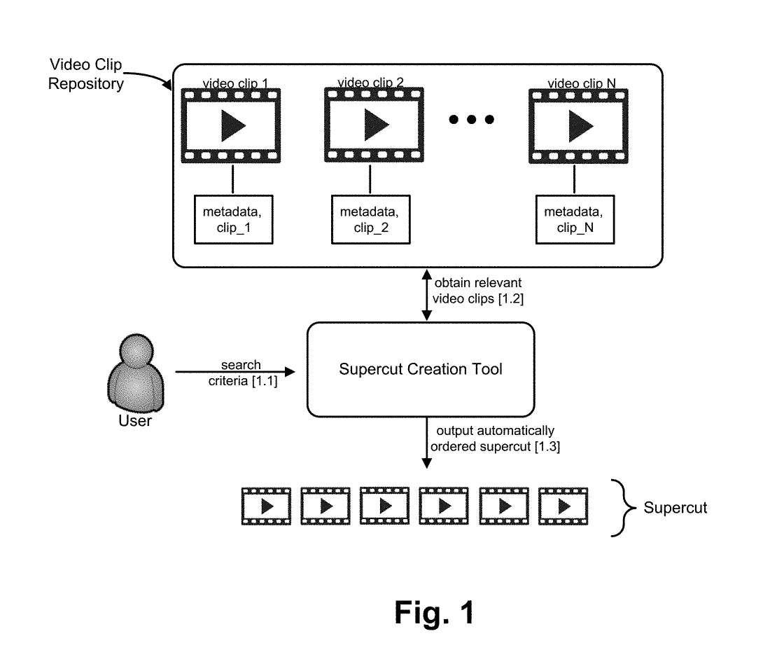

Implementations described herein may operate to assist users in automatically selecting and arranging video clips to form supercuts. For example, as shown in FIG. 1, a video clip repository may include a number of video clips. Each of the video clips may represent a section of a video (e.g., a movie, television show, or other video) that was in some way identified. Each video clip may be, for example, on the order of a second or two in length up to 10 or 20 seconds, or more, in length. The video clips may have been identified by users of a content provider, by the content provider, and/or by the content creator (i.e., the creator of the movie/television show), as video clips that are particularly interesting or important. In some implementations, each of the video clips may be associated with metadata, such as user comments associated with the video clips, user-generated tags associated with the video clips, relevance or ranking information session with the video clips, or other metadata.

The video clip repository may allow users to browse and view video clips in the repository. For example, a user may choose to view video clips (and potentially the metadata) associated with a particular video, such as video clips defined by other users that have watched the video. The video clip repository may include or be associated with a supercut creation tool. The supercut creation tool may enable users to efficiently select and arrange video clips to form a supercut, without requiring the user to manually search through videos, define clips, and import video clips to create the supercut. The supercut creation tool, as described herein, may provide for significant time savings and for the creation of higher quality supercuts relative to manual creation of a supercut.

As an example of the operation of the supercut creation tool, a user may input one or more search terms, or select one or more categories, relating to video clips that the user is interested in potentially including in a supercut (at 1.1, “search criteria”). For example, the user may enter the names of particular actors, movie titles, directors, or other information. The supercut creation tool may search the video clip repository, such as by searching the metadata associated with the video clips, to determine video clips relevant to the user's search (at 1.2, “obtain relevant video clips”). In some implementations, the supercut creation tool may automatically select video clips and select and an arrangement of the video clips for the supercut (at 1.3, “output supercut with automatically ordered video clips”). In one implementation, the video clips stored by the video clip repository may be associated with a score that quantifies the quality or popularity of each video clip. In one implementation, the supercut creation tool, when automatically arranging the video clips in the supercut, may insert the highest scoring video clip as the first video clip in the supercut and the second highest scoring video clip as the last video clip in the supercut. In this implementation, putting the highest scoring video clip as the first video clip may to tend to maximize the ability of the supercut to grab the viewer's attention and putting the second highest scoring video clip as the last video clip may increase the likelihood that a viewer of the supercut may be motivated to share or otherwise recommend the supercut.

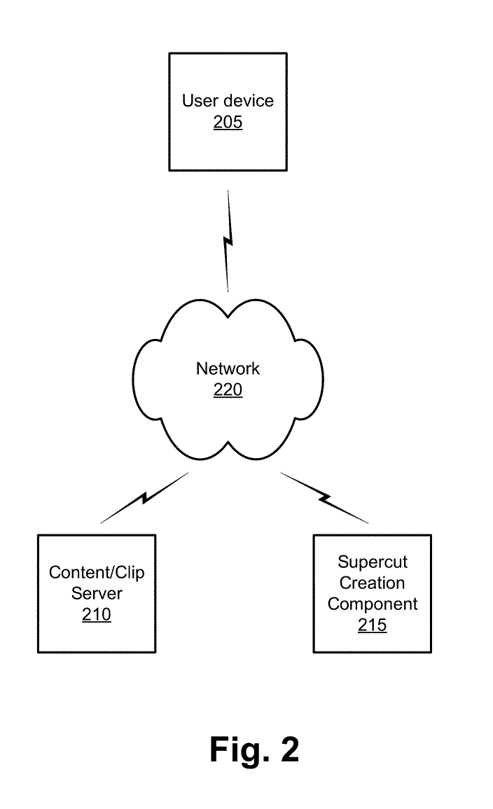

FIG. 2 illustrates an example environment 200, in which systems and/or methods described herein may be implemented. As shown in FIG. 2, environment 200 may include user device 205, content/clip server 210, supercut creation component 215, and network 220.

The quantity of devices and/or networks, illustrated in FIG. 2, is provided for explanatory purposes only. In practice, environment 300 may include additional devices and/or networks; fewer devices and/or networks; different devices and/or networks; or differently arranged devices and/or networks than illustrated in FIG. 2. For example, while not shown, environment 200 may include devices that facilitate or enable communication between various components shown in environment 200, such as routers, modems, gateways, switches, hubs, etc. Alternatively, or additionally, one or more of the devices of environment 200 may perform one or more functions described as being performed by another one or more of the devices of environment 200. Devices of environment 200 may interconnect with each other and/or other devices via wired connections, wireless connections, or a combination of wired and wireless connections. In some implementations, one or more devices of environment 200 may be physically integrated in, and/or may be physically attached to, one or more other devices of environment 200. Also, while “direct” connections are shown in FIG. 2 between certain devices, some devices may communicate with each other via other networks or links.

User device 205 may include any computation and communication device that is capable of communicating with one or more networks (e.g., network 220). For example, user device 205 may include a radiotelephone, a personal communications system (“PCS”) terminal (e.g., a device that combines a cellular radiotelephone with data processing and data communications capabilities), a personal digital assistant (“PDA”) (e.g., a device that includes a radiotelephone, a pager, etc.), a smart phone, a laptop computer, a tablet computer, a camera, a television, a set-top device (“STD”), a personal gaming system, a wearable device, and/or another type of computation and communication device. User device 205 may include logic and/or hardware circuitry to communicate via one or more “short range” wireless protocols, such as WiFi (e.g., based on an Institute of Electrical and Electronics Engineers Institute of Electrical and Electronics Engineers (“IEEE”) 802.11-based standard), Bluetooth, Near Field Communications (“NFC”), ZigBee (e.g., based on an IEEE 803.15.4-based standard), or the like. User device 205 may also include logic and/or hardware circuitry to communicate via a wireless telecommunications protocol (e.g., via network 220), such as Long-Term Evolution (“LTE”), Third Generation Partnership Project (“3GPP”) Third Generation (“3G”), Code Division Multiple Access (“CDMA”) 2000 1×, and/or another wireless telecommunications protocol.

Content/clip server 210 may include one or more computing server devices (e.g., a single physical device or a distributed set of devices) that perform one or more functions related to storing and/serving content. The content may include video content, such as movies, television shows, user created videos, or other video content. Content/clip server 210 may also store and/or provide video clips. In some implementations, content/clip server 210 may separately store the video clips as video content items. Alternatively or additionally, content/clip server 210 may maintain the video clips as references to the starting and stopping time point, of a video clip, within the source video content (i.e., content/clip server 210 may not necessarily store a separate copy of the video corresponded to a video clip). Although described as a single “content/clip server 210,” in some implementations, content/clip server 210 may be implemented as different server servers that store the full video content (e.g., the full move, television show, etc., from which the video clips are derived) and the video clips.

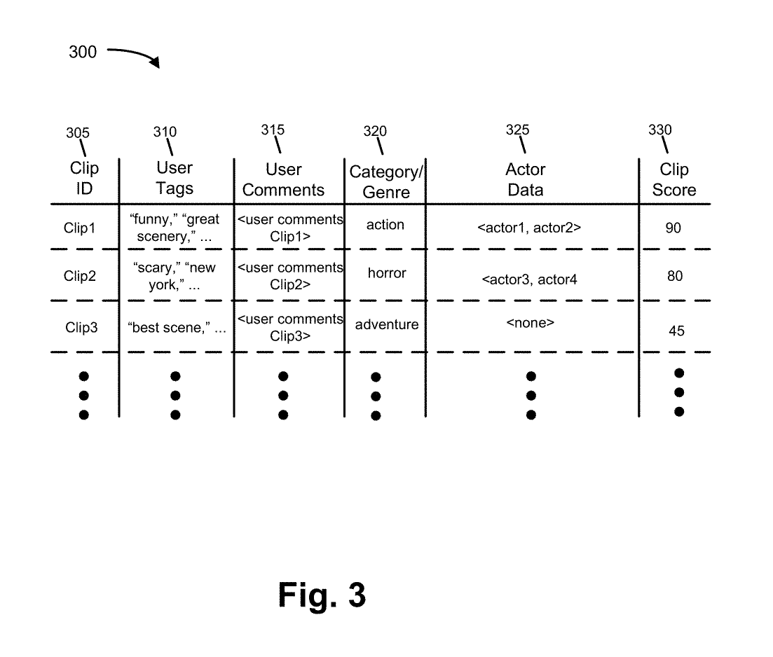

Content/clip server 210 may also maintain metadata relating to the video clips. The metadata may include user comments associated with the video clips, user-generated tags associated with the video clips, relevance or ranking information session with the video clips, or other metadata. The contents of the metadata will be described in more detail below with reference to FIG. 3.

In some implementations, the video clips stored by content/clip server 210 may be defined by users. For example, the playback application associated with video content may allow users to “mark” sections of the video (e.g., sections that users find interesting). The marked sections may be used to obtain the video clips. Content/clip server 210 may aggregate the marked sections, from a large number of users, to determine sections that are particularly popular or are otherwise frequently marked by users. Content/clip server 210 may define video clips from these sections.

Supercut creation component 215 may include one or more computing devices (e.g., a single physical device or a distributed set of devices) that enable or assist users in selecting and/or arranging video clips to form a supercut. In various implementations, supercut creation component 215 may be implemented as a server or cluster of servers that implement the concepts described herein; as a process implemented by a server, as a process implemented at content/clip server 210, or a process implemented a user device 205; and/or as a web service. Supercut creation component 215 may communicate with content/clip server 210 to obtain video clips and metadata associated with the video clips. The operation of supercut creation component 215 will be described in more detail below.

Network 220 may include one or more radio access networks (“RANs”), via which user device 205 may access one or more other networks or devices, a core network of a wireless telecommunications network, an Internet Protocol (“IP”)-based PDN, a wide area network (“WAN”) such as the Internet, a private enterprise network, and/or one or more other networks. User device 205 may connect, via network 220, to data servers, application servers, other user devices 205, etc. Network 220 may be connected to one or more other networks, such as a public switched telephone network (“PSTN”), a public land mobile network (“PLMN”), and/or another network.

FIG. 3 is a diagram illustrating an example data structure 300 illustrating various types of metadata that may be associated with video clips. Data structure 300 may be maintained by, for example, content/clip server 210. Although a number of fields are shown in data structure 300, in other examples, data structure 300 may include fewer or additional fields.

As shown in FIG. 3, each record in data structure 300 may correspond to a particular video clip. Data structure 300 may include clip identifier (ID) field 305, user tags field 310, user comments field 315, category/genre field 320, actor data field 325, and clip score field 330. Clip ID field 305 may include an identifier that identifies a particular video clip (e.g., “Clip1”, “Clip2”, “Clip3”). In some implementations, clip ID field 305 may include an indication of a particular video (e.g., a movie title or identifier of a video), a start time of the clip in the particular video, and an end time of the clip in the particular video. In other implementations, clip ID field 305 may include links to the stored version of a video clip.

User tags field 310 may be used to store user-generated tags that correspond to the video clip. In some implementations, content/clip server 210, when serving videos or video clips to users, may allow users to enter feedback relating to the video with the video clip, such as user-generated identification tags (e.g., “funny,” “great scenery,” etc.”). Content/clip server 210 aggregate tags from multiple users and/or determine popular tags for particular video clips. In some implementations, the tags stored in user tags field 310 may be tags generated by an operator of content/clip server 210, by the producer or owner of the content, or by other entities. In general, the tags may be used to provide supplemental information relating to the content of the video clip. User comments field 315 may be used to store user-generated comments associated with the video clip with a corresponding video. The comments may be directly entered by a user while watching the video or video clip, extracted from social media sites, extracted from other online sites, or otherwise obtained. In some implementations, the user tags may also be extracted, or otherwise obtained, from user comments.

Category/genre field 320 may include information relating to the category or genre of a particular video clip and/or to the corresponding full video. For example, a movie may be in the “horror” genre but a particular five-second clip from the movie may be humorous moment from movie. In this example, category/genre field 320 may indicate “comedy,” even though the full movie is of the “horror” genre. Alternatively, in this example, category/genre field 320 may indicate both “horror” and “comedy.”

Actor data field 325 may include information identifying the actors in the video clip or information identifying other aspects of the video clip (e.g., the scene/location of the video clip). In some implementations, actor data field 325 (or another field) may include other information, such as information associated with the full video (e.g., the movie from which the clip is derived), such as the complete list of actors, the director, the title of the movie, etc.

Clip score field 330 may include a numerical value (“score”) that defines the quality or popularity of the video clip. Content/clip server 210 may calculate the value for clip score field 330. For example, in one implementation, the score may define the popularity of the video clip, as measured by the number of times that the video clip has been watched relative to other video clips (e.g., on a scale between 1 and 100) or a frequency at which video clip is watched by various users. In some implementations, other factors may be used to generate or refine the score, such as the popularity of the full video (e.g., as measured by box office revenue or how often the full video is watched), the length of the video clip, the amount of dialog relative to other sounds (e.g., music or action sounds) in the video clip, etc.

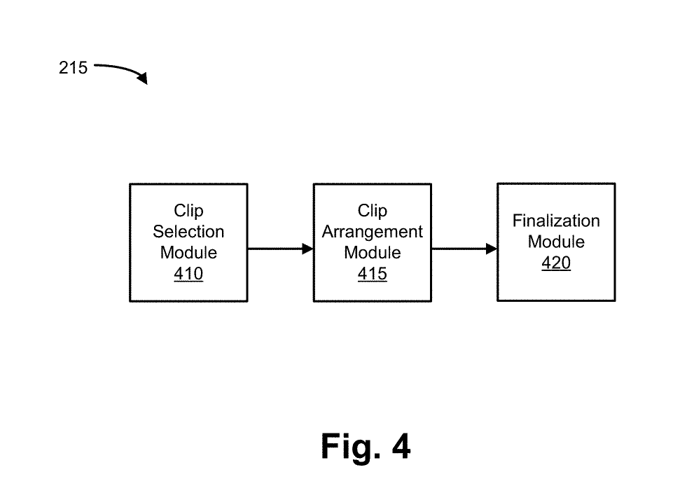

FIG. 4 is a diagram conceptually illustrating functional elements of supercut creation component 215. As shown, supercut creation component 215 may include clip selection module 410, clip arrangement module 415, and finalization module 420. Each of modules 410, 415, and 420 may correspond to, for example, functional logic implemented by supercut creation component 215.

Clip selection module 410 may include logic to assist users in selecting candidate video clips for a supercut. Clip selection module 410 may, for example, receive user input describing clips that the user is interested in using for a supercut. For example, the user may provide one or more search terms, such as identification of actor(s), a movie or television show(s), a genre(s), and/or particular user tags. In response, clip selection module 410 may search the available video clips to determine potentially relevant video clips. For example, clip selection module 410 may submit a search query to content/clip server 210 to obtain the potentially relevant video clips. Content/clip server 210 may perform the search using, for example, data structure 300. Alternatively or additionally, clip selection module 410 may locally store data structure 300 and may perform the search without using content/clip server 210.

Clip arrangement module 415 may automatically arrange the potential video clips, obtained by clip selection module 410, into a supercut. For example, clip arrangement module 415 may automatically select an order of the video clips for the supercut. The order may be based on, for example, the scores associated with the video clips. In one implementation, clip arrangement module 415 may use the highest scoring video clip as the first video clip (i.e., the first video clip shown in the supercut) and the second highest scoring video clip as the last video clip in the supercut (i.e., the last video clip shown in the supercut). The video clips between the first and last video clip may be arranged in a number of different ways, such as by randomly ordering the middle video clips, ordering the middle video clips based on the corresponding scores of the video clips (e.g., the highest scoring video clip, of the middle video clips, may be the second video clip, the next highest scoring video clip, of the middle video clips, may be the third video clip, etc.), ordering the middle video clips by length, or ordering the middle video clips based on some other technique (such as a user-specified ordering technique).

Finalization module 420 may present the supercut to the user and may provide the user an opportunity to finalize the arrangement and/or selection of the video clips in the supercut. For example, finalization module 420 may provide a graphical interface (e.g., a web-based interface) in which each video clip is represented graphically and in which the user can “drag” the graphical representations to reorder the video clips in the supercut. When the user is satisfied with the supercut, finalization module 420 may convert the video clips, in the supercut, to a single, continuous video, to create the supercut. Finalization module 420 may store the supercut, publish the supercut (e.g., to a content delivery site, such as content/clip server 210), or otherwise provide the supercut to the user.

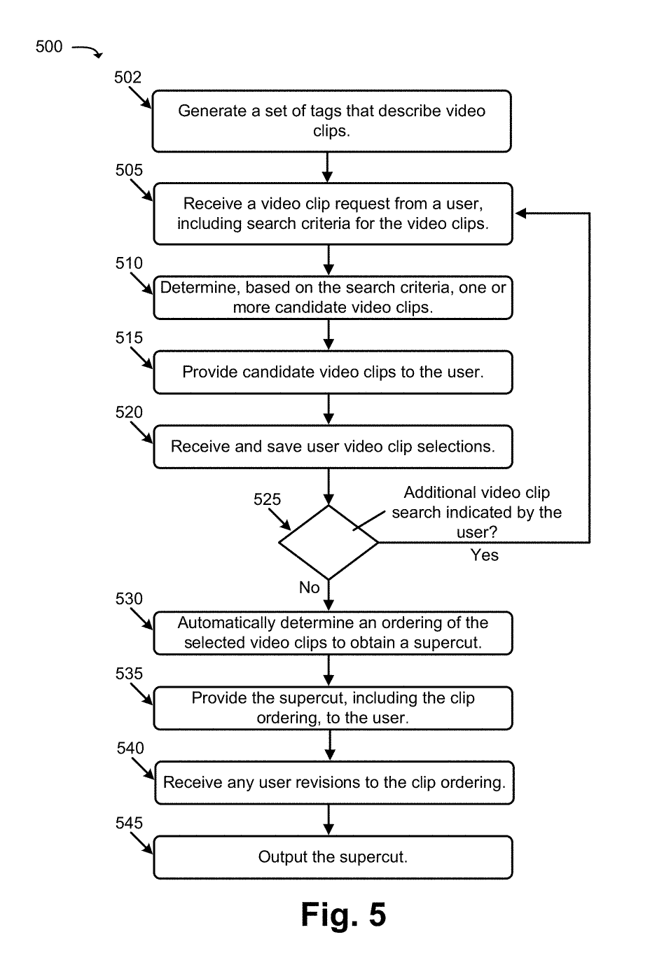

FIG. 5 illustrates an example process 500 for the creation of supercuts. In some implementations, some or all of process 500 may be performed by supercut creation component 215 and/or one or more other devices.

Process 500 may include generating a set (i.e., a corpus) corpus of tags that describe video clips (block 502). As previously mentioned, the tags may be tags that correspond to user tags of video clips, extracted from user comments relating to videos or video clips, defined by a creator of a video, or otherwise obtained. The generation of the set of tags may be performed relatively infrequently, such as once a day, week, or month.

As shown, process 500 may further include receiving a video clip request from the user. The video clip request may include search criteria relating to video clips (at 505). The search criteria, may include, for example, criteria limiting the search to particular genres (“horror”), tags, particular actors, particular directors, particular movies, particular TV shows, or other criteria. In general, the search criteria may relate to any criteria that is indexed for the stored video clips (e.g., as stored by content/clip server 210 in data structure 300). As other examples, the search criteria may be applied to user tags or user comments. As another example, the search criteria may indicate that the search for video clips is to be performed for video clips that were seen or commented-on by friends of the user (e.g., as indicated by membership in a social network).

Process 500 may further include determining one or more candidate video clips (at 510). For instance, supercut creation component 215 may, based on the search criteria, perform a search for relevant video clips. In some implementations, the scores (e.g., the scores shown in clip score field 330) associated with each video clip may be used to refine the search results (e.g., if 200 video clips are determined based on the search criteria, only the top 50, as measured by the video clip score, may be returned to the user). In some implementations, supercut creation component 215 may perform the search by querying content/clip server 210. Alternatively, the functionality of supercut creation component 215 may be integrated within of content/clip server 210.

In some implementations, in addition to video clips, “full” video content items (e.g., movies, television shows, etc., or links to such content) may also be identified in response to a video clip request. The user may then be given the opportunity to manually define video clips, such as by specifying a beginning and ending point within the full video content, to define a video clip.

Process 500 may further include providing the video clips (or links to video clips) to the user (at 515). For instance, clip selection module 410, of supercut creation component 215, may transmit the determined candidate video clips (or links or references to the candidate video clips) to the user (i.e., to user device 205 of the user).

In some implementations, the user may view and potentially select one or more of the provided video clips. The user selections, of video clips, may be transmitted back to supercut creation component 250, which may receive and save the video clip selections (at 520). Supercut creation component 215 may provide the user an opportunity to enter additional search criteria to select additional video clips (at 525). For example, when the user indicates (e.g., though a graphical selection process) that additional video clips are desired (at 525, “Yes”), the operations at 505-520 may be iteratively repeated until the user is satisfied with the selected video clips.

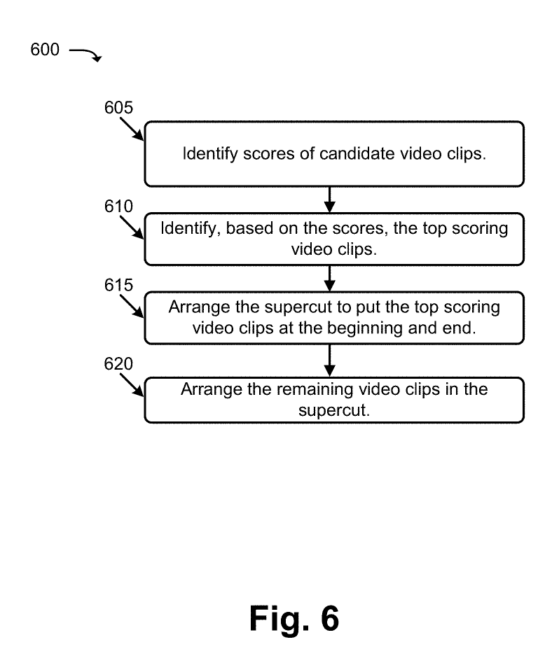

When the user is satisfied with the selected video clips, process 500 may further include automatically determining an ordering of the selected video clips to obtain a supercut (at 530). The automatic ordering of the selected video clips may be performed, for example, by clip arrangement module 415. Example techniques for determining the order of the video clips, in the supercut, are described in more to tell below with reference to FIG. 6.

Process 500 may further include providing the supercut, including the determined clip ordering, to the user (at 535). The video clips (or links to the video clips) in the supercut may thus be transmitted to user device 205. For example, supercut creation component 215 may display the video clips in the supercut, in the determined order, via a web interface or via another graphical interface, such as a graphical interface provided via a client application that executes at user device 205. The user may potentially be given a chance to edit the ordering of the video clips in the supercut. For example, a graphical interface may be provided via which the user can select a video clip and drag the video clip to a different location in the supercut. The user-revised order of the video clips in the supercut may be received from the user (at 540). When the user is satisfied with the supercut, process 500 may further include outputting the supercut (at 545). For example, supercut may be downloaded (e.g., as a single video file) by user device 205, published to social media or to another content host, or otherwise saved.

FIG. 6 illustrates an example process 600 for automatically determining an ordering of video clips in a supercut. Process 600 may be performed, for example, by clip arrangement module 415 of supercut creation component 215, as part of the process performed at 530 (FIG. 3).

Process 600 may include identifying the scores of the candidate video clips (at 605). As previously mentioned, the video clips may be associated with a score that quantifies the quality or popularity of each video clip. Supercut creation component 215 may, for example, obtain the scores from content/clip server 210.

Process 600 may further include identifying, based on the scores, the top scoring video clips (at 610). In one implementation, the first and second highest scoring video clips may be identified (i.e., the video clip associated with the highest and the second highest score may be identified). For example, a list of the candidate video clips may be sorted, in descending order, by score. The highest and second highest scoring video clips can thus be determined as the video clips in the top two spots of the list.

Process 600 may further include arranging the supercut to put the top scoring video clips at the beginning and end of the supercut (at 615). In one implementation, the top scoring video clip may be placed at the beginning of the supercut and the next highest scoring video clip may be assigned to the last position in the supercut. Alternatively, the top scoring video clip may be placed at the end of the supercut and the second highest scoring video clip may be assigned to the first position in the supercut. As another possible implementation, the top four candidate video clips may be determined, and two of the top four video clips assigned to the beginning of the supercut and the other two of the top four candidate video clips assigned to the end of the supercut. By putting the higher scoring video clips at the beginning and end of the supercut, viewers may be more likely to become quickly engaged in the supercut (and thus more likely watch the supercut to completion) and may be more likely to finish watching the supercut and have a favorable impression.

Process 600 may further include arranging the remaining candidate video clips in the supercut (at 620). In one implementation, the remaining video clips may be inserted in the supercut based on the scores of the video clips. For example, the remaining video clips may be arranged in sorted order in the supercut (e.g., highest score towards the beginning and lowest score towards the end, or vice-versa). As another example, the order of the remaining video clips may be randomly distributed in the supercut. In some implementations, other factors, such as the length of the video clips, or other factors, may be used in determining the order of the remaining supercuts.

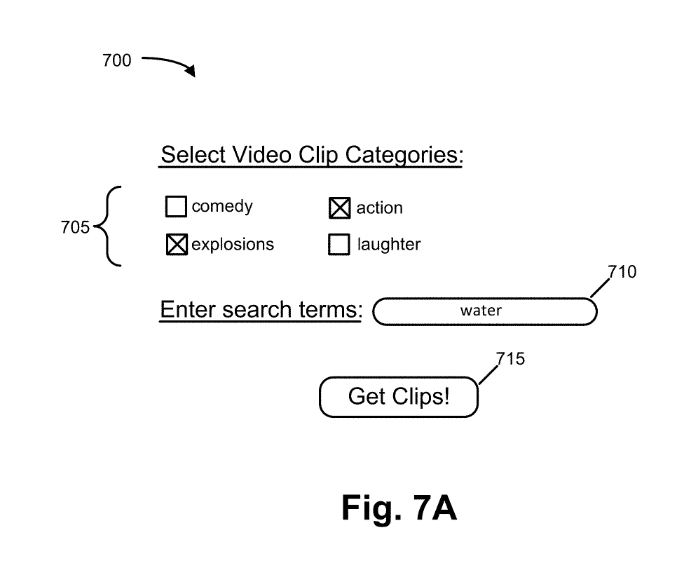

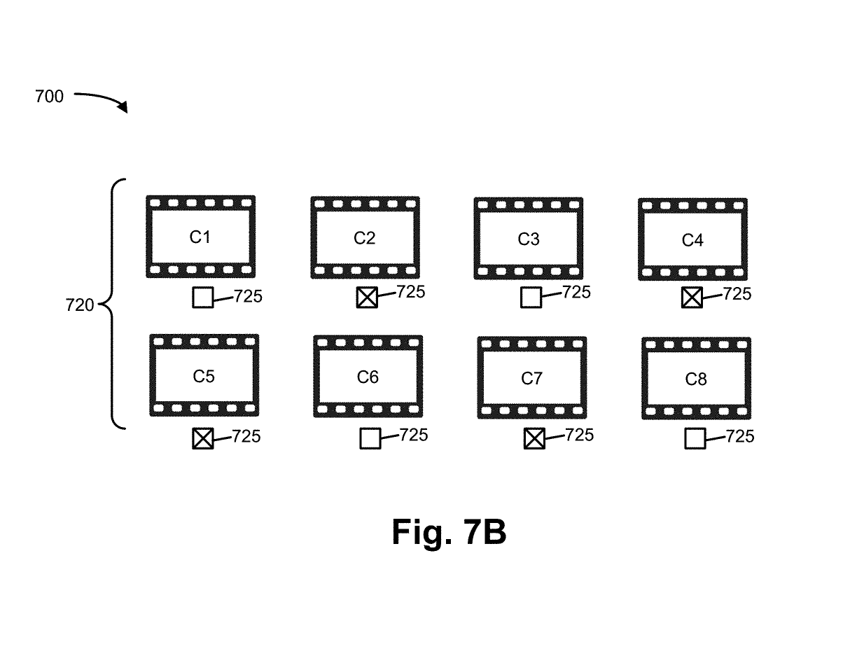

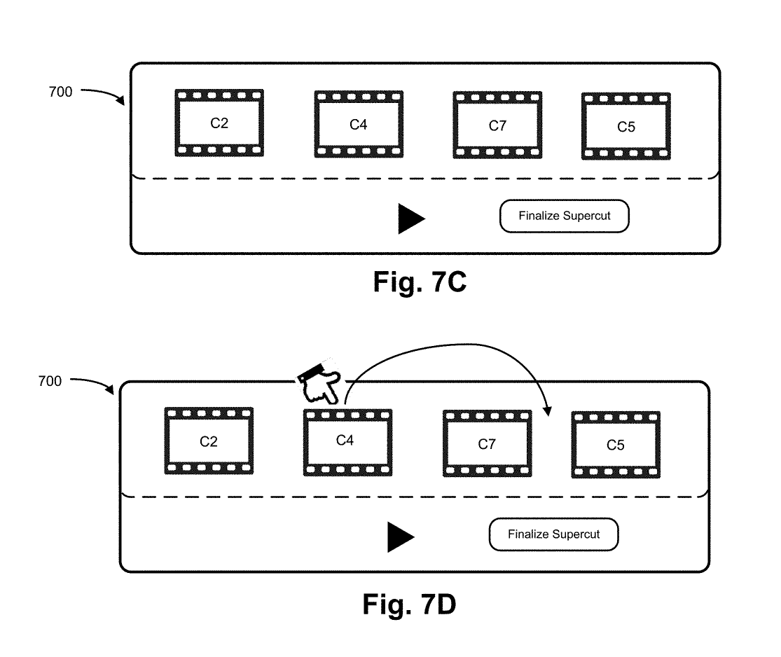

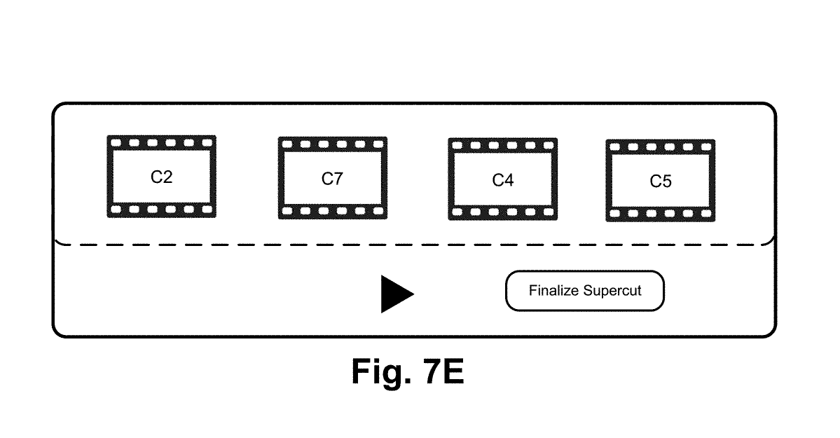

An example application of a user creating a supercut, using supercut creation component 215, will next be described with reference to FIGS. 7A-7E. FIGS. 7A-7E illustrate example states of a graphical user interface 700. Via interface 700, a user may interact, with user device 205, supercut creation component 215, and/or content/clip server 210, when creating a supercut. Interface 700 may be presented by, for example, user device 205 to a user.

Interface 700, as shown in FIG. 7A, may be used to receive user search criteria for video clips. For example, as shown in FIG. 7A, a user may select one or more categories 705 in which the user is interested. Categories 705 may be determined by supercut creation component 215 and may correspond to predefined genres, user created tags, or other data. For example, in one implementation, supercut creation component 215 may define the categories as corresponding to user-generated tags from the video clips that are commonly viewed (i.e., popular video clips). In another possible implementation, the category data may correspond to the genre of the movies/television shows of the video clips maintained by content/clip server 210. Although only four category labels are illustrated in FIG. 7A, in practice, a user may be shown more than four category labels. Also, as shown in FIG. 7A, the user has selected the tags “explosions” and “action.”

Interface 700 may also provide the user an option to enter search terms. As illustrated, a text entry block 710 may be presented by which a user can enter one or more search terms. For example, the user may enter the titles of content, actors, directors, terms describing the type of video clips in which the user is interested, or other information. In the example of FIG. 7A, the user has entered the search terms “water,” which may indicate that the user is interested in tags that include the term “water” and/or content that includes the term “water” in the title.

The graphical button “Get Clips!” 715 is also shown in FIG. 7A. The user may select button 715 when the user is ready to submit the selected search. In response, user device 205 may transmit the user entered search information (e.g., the category information and/or the search terms) to supercut creation component 215.

FIG. 7B may represent interface 700 after supercut creation component 215 returns an initial set of candidate video clips to the user. As shown, candidate video clips 720 may include eight candidate video clips, labeled as video clips C1-C8. The user may, for example, select a particular video clip, such as by “double-clicking” on the video clip, to play the video clip. Check-boxes 725 are illustrated for the video clips, which may be used to indicate which video clips the user would like to include in the supercut. In this example, video clips C2, C4, C5, and C7 are indicated as being video clips that the user would like to use in the supercut.

FIG. 7C may represent interface 700 after supercut creation component 215 returns a supercut, including an automatically determined ordering of the video clips in the supercut. In this example, the automatic ordering of the video clips was determined as C2, C4, C7, and C5. For instance, video clip C2 may be determined as a highest-ranking video clip, and video clip C5 may have been determined as the second highest-ranking video clip. Interface 700 may also include a “play” icon, through which the user can initiate playback of the a supercut, and a “finalize supercut” button, the selection of which may indicate that the user is satisfied with the supercut and is ready to save or otherwise publish the supercut.

As shown in FIG. 7D, assume that the user chooses to manually adjust the ordering of the video clips in the supercut. For example, the user may perform a drag operation to drag video clip C4 after video clip C7. The new ordering of the video clips in the supercut may thus be C2, C7, C4, and C5. This new ordering of the video clips in the supercut as shown in FIG. 7E.

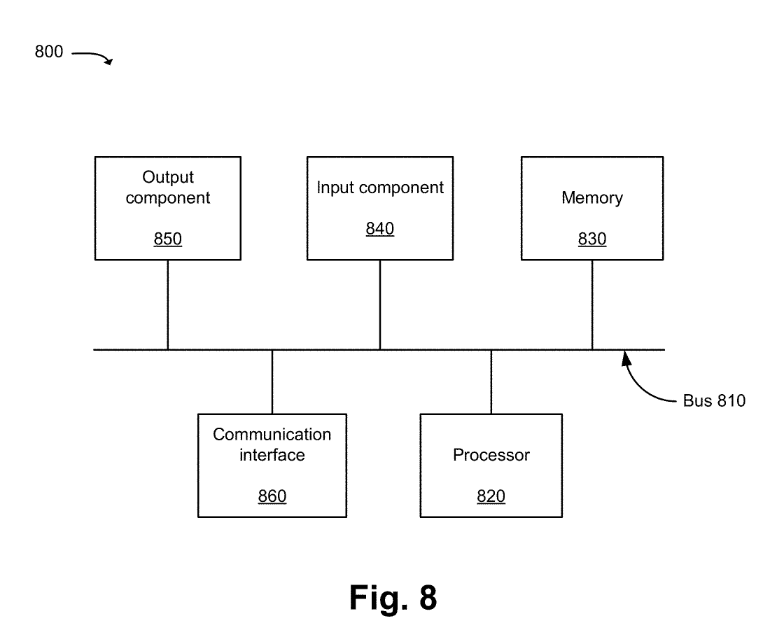

FIG. 8 is a diagram of example components of device 800. One or more of the devices described above may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (“LEDs”), etc. Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, in some implementations, various techniques, some examples of which have been described above, may be used in combination, even though such combinations are not explicitly discussed above. Furthermore, some of the techniques, in accordance with some implementations, may be used in combination with conventional techniques.

Additionally, while series of blocks have been described with regard to FIGS. 5 and 6, the order of the blocks and/or signals may be modified in other implementations. Further, non-dependent blocks and/or signals may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A computing device comprising:
a non-transitory memory device storing a set of computer-executable instructions; and
a processor configured to execute the set of computer-executable instructions, wherein executing the set of computer-executable instructions causes the processor to:
generate a set of tags that describe a set of video clips, each video clip from the set corresponding to a section of a full video and each of the video clips being shorter in length than the corresponding full video, and the video clips from the set being associated with corresponding scores that measures a quality or popularity of the video clips;
identify, based on comparison of search criteria received from a user to the set of tags, a plurality of video clips, from the set of video clips, that are relevant to the search criteria;
determine, based on the scores of the plurality of video clips, an ordering of the plurality of the video clips;
generate a supercut of the plurality of video clips as a single video corresponding to the plurality of the video clips and arranged in the determined order; and
output the supercut.

2. The computing device of claim 1, wherein the set of computer-executable instructions, when executed by the processor, is further to cause the processor to:
identify, based on the scores, a highest ranking one of the plurality of video clips; and
identify, based on the scores, a second highest ranking one of the plurality of video clips,
wherein the determination of the order of the plurality of video clips includes locating the highest ranking one of the plurality of video clips and the second highest ranking one of the plurality of video clips at a first and last position of the order.

3. The computing device of claim 2, wherein the highest ranking of the plurality of video clips is located at the first position of the order and the second highest ranking of the plurality of video clips is located at the last position of the order.

4. The computing device of claim 1, wherein the full video is a movie or television show.

5. The computing device of claim 1, wherein the set of computer-executable instructions, when executed by the processor, is further to cause the processor to:
provide the plurality of video clips to a user device of the user before the determination of the order of the plurality of video clips; and
receive a final selection, of the plurality of video clips, from the user device.

6. The computing device of claim 1, wherein the set of computer-executable instructions, when executed by the processor, is further to cause the processor to:
receive the search criteria from a user device of the user, the search criteria including selection, by the user, of one or more tags from the set of tags.

7. The computing device of claim 5, wherein the search criteria further includes search terms provided by the user.

8. The computing device of claim 1, wherein the video clips, of the set of video clips, include user-defined video clips.

9. The computing device of claim 1, wherein at least some of the tags, from the set of tags, are derived from user comments relating to the full videos.

10. A method, implemented by a server device, comprising:
generating a set of tags that describe a set of video clips, each video clip from the set corresponding to a section of a full video and each of the video clips being shorter in length than the corresponding full video, and the video clips from the set being associated with corresponding scores that measures a quality or popularity of the video clips;
identifying, based on comparison of search criteria received from a user to the set of tags, a plurality of video clips, from the set of video clips, that are relevant to the search criteria;
determining, based on the scores of the plurality of video clips, an ordering of the plurality of the video clips;
generating a supercut of the plurality of video clips as a single video corresponding to the plurality of the video clips and arranged in the determined order; and
outputting the supercut.

11. The method of claim 10, further comprising:
identifying, based on the scores, a highest ranking one of the plurality of video clips; and
identifying, based on the scores, a second highest ranking one of the plurality of video clips,
wherein the determination of the order of the plurality of video clips includes locating the highest ranking one of the plurality of video clips and the second highest ranking one of the plurality of video clips at a first and last position of the order.

12. The method of claim 11, wherein the highest ranking of the plurality of video clips is located at the first position of the order and the second highest ranking of the plurality of video clips is located at the last position of the order.

13. The method of claim 10, further comprising:
providing the plurality of video clips to a user device of the user before the determination of the order of the plurality of video clips; and
receiving a final selection, of the plurality of video clips, from the user device.

14. The method of claim 10, further comprising:
receiving the search criteria from a user device of the user, the search criteria including selection, by the user, of one or more tags from the set of tags.

15. The method of claim 14, wherein the search criteria further includes search terms provided by the user.

16. The method of claim 10, wherein the video clips, of the set of video clips, include user-defined video clips.

17. A non-transitory computer readable medium containing program instructions for causing one or more processors to:
generating a set of tags that describe a set of video clips, each video clip from the set corresponding to a section of a full video and each of the video clips being shorter in length than the corresponding full video, and the video clips from the set being associated with corresponding scores that measures a quality or popularity of the video clips;
identifying, based on comparison of search criteria received from a user to the set of tags, a plurality of video clips, from the set of video clips, that are relevant to the search criteria;
determining, based on the scores of the plurality of video clips, an ordering of the plurality of the video clips;
generating a supercut of the plurality of video clips as a single video corresponding to the plurality of the video clips and arranged in the determined order; and
outputting the supercut.

18. The non-transitory computer readable medium of claim 17, wherein the program instructions further cause the one or more processors to:
identify, based on the scores, a highest ranking one of the plurality of video clips; and
identify, based on the scores, a second highest ranking one of the plurality of video clips,
wherein the determination of the order of the plurality of video clips includes locating the highest ranking one of the plurality of video clips and the second highest ranking one of the plurality of video clips at a first and last position of the order.

19. The non-transitory computer readable medium of claim 18, wherein the highest ranking of the plurality of video clips is located at the first position of the order and the second highest ranking of the plurality of video clips is located at the last position of the order.

20. The non-transitory computer readable medium of claim 17, wherein the video clips, of the set of video clips, include user-defined video clips.
